(19) United States
(12) Patent Application Publication
(10) Pub. No.: US 2009/0029194 A1
(43) Pub. Date: Jan. 29, 2009

(54) UNINTERRUPTED POWER SUPPLY CIRCUIT

(76) Inventor: Pierre Charlat, Lans En Vercors (FR)

Correspondence Address: AIR LIQUIDE;Intellectual Property, 2700 POST OAK BOULEVARD, SUITE 1800, HOUSTON, TX, 77056, US

(21) Appl. No.: 11/913,249

(22) PCT Filed: Apr. 19, 2006
(86) PCT No.: PCT/FR2006/050354

§ 371 Date: Jun. 9, 2008

(30) Foreign Application Priority Data
May 3, 2005 (FR) 0551159

(51) Int. Cl. H02J 9/06; H01M 8/00

(52) U.S. Cl. 429/9

(57) ABSTRACT

The invention relates to an uninterrupted power supply circuit starting from an alternating current source (10) comprising a fuel cell back-up system (50; 50′), characterized in that the back-up system comprises: a fuel cell (52); a battery (51) for starting the fuel cell (52) joined to said alternating current source on an input terminal (501) of the back-up system (50, 50′), said starting battery (51) and fuel cell (52) being connected in parallel to an output terminal (502) of the system (50, 50′) that is distinct from the input terminal.

The present invention relates to an uninterrupted power supply circuit.

The invention finds a particularly advantageous application in the field of supplies for powering DC equipment from an AC source.

In numerous industrial installations, certain applications, such as telecommunications racks, are powered by a DC voltage allowing the operation of the electronic equipment, at a DC voltage of 48 V in the aforesaid case of telecommunications.

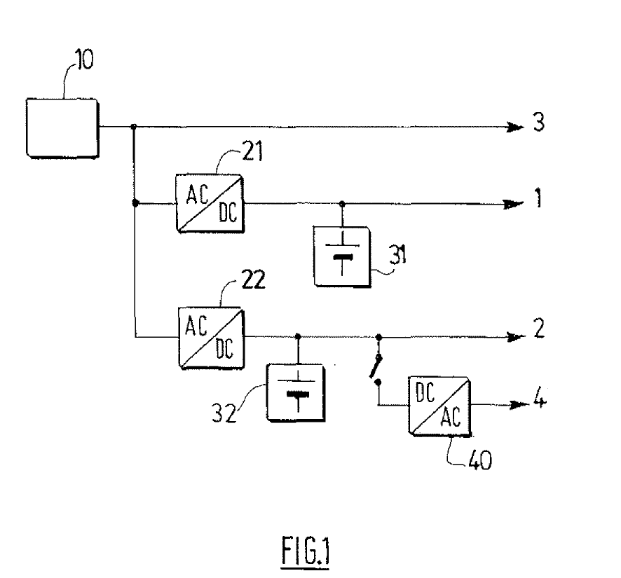

A conventional architecture, an example of which is given in FIG. 1, consists in using a low-voltage AC source 10 provided by the local electrical network, that is to say downstream of a high-voltage/low-voltage transformer. AC/DC converters 21, 22 make it possible, on the one hand, to supply DC power to electronic equipment 1, 2, and, on the other hand, to charge batteries 31, 32 connected to the supply bus. In parallel, certain ancillary utility equipment 3 is still supplied with AC directly on the local network, while other equipment 4 is supplied with AC by way of DC/AC converters, such as the converter 40 in series with the AC/DC converter 22.

When the AC supply from the network is interrupted, the DC supply for the equipment of the telecommunications rack, for example, is ensured by the batteries 31, 32. Continuity of the DC supply is thus guaranteed in the event that the network is interrupted.

However, this known solution exhibits the drawback of a degree of autonomy limited to that allowed by the batteries. Moreover, batteries are sensitive to the various temperature conditions and their servicing cost remains high.

Documents DE10243213 and US2004/053093 describe uninterrupted power supply circuits based on an AC source using a fuel cell.

These known systems require the use, however, of one or more main backup batteries intended in particular for ensuring the starting of the fuel cell or to keep the latter charged. This solution exhibits the following drawbacks: necessity to envision one or more batteries rated accordingly.

So, the technical problem to be solved by the subject of the present invention is to propose an uninterrupted power supply circuit based on an AC source, which would make it possible to avoid or, at least, limit the use of batteries to power electrical equipment in the event that the AC supply is interrupted, or indeed even under nominal conditions.

A solution to the technical problem posed consists, according to the present invention, in that said circuit comprises a backup system with fuel cell, characterized in that the backup system comprises:
a fuel cell,
a battery for starting the fuel cell connected to said AC source on an input terminal of the backup system, said starting battery and the fuel cell being connected in parallel to an output terminal of the system that is different from the input terminal.

According to a first embodiment of the invention, a breaker is disposed on said output terminal. As will be seen in detail further on, this solution makes it possible to supply power to the electronic equipment with a single battery under nominal conditions, that is to say with no interruption of the AC supply, the power supply circuit in accordance with the invention being implemented only during such an interruption.

According to a second embodiment of the invention, a breaker is disposed between the fuel cell and said output terminal. It will also be seen further on that this solution exhibits the advantage of avoiding the use of any battery to power the electronic equipment, the DC supply being in this case provided entirely by the circuit in accordance with the invention be it under nominal conditions or during an interruption of the AC supply.

According to other possible features;
the starting battery is connected to the AC source (10) by way of an AC/DC converter,
the starting battery and the fuel cell are connected to the output terminal of the fuel cell backup system by way of respective DC/DC converters (512, 522),
a filtering capacitor is placed at the level of the output of the starting battery and of the fuel cell,
the circuit comprises a backup battery situated downstream of the output terminal on a supply line for powering an item of electronic equipment from the source,
the backup system with fuel cell is kept energized by the AC source,
the starting battery is kept charged by the AC source when said source is operating and by the fuel cell when the latter is turned on, in particular in the event of failure of the source.

The description which will follow in regard to the appended drawings, given by way of nonlimiting examples, will clearly elucidate the gist of the invention and how it may be embodied.

FIG. 1 is a diagram of a power supply installation according to the prior art.

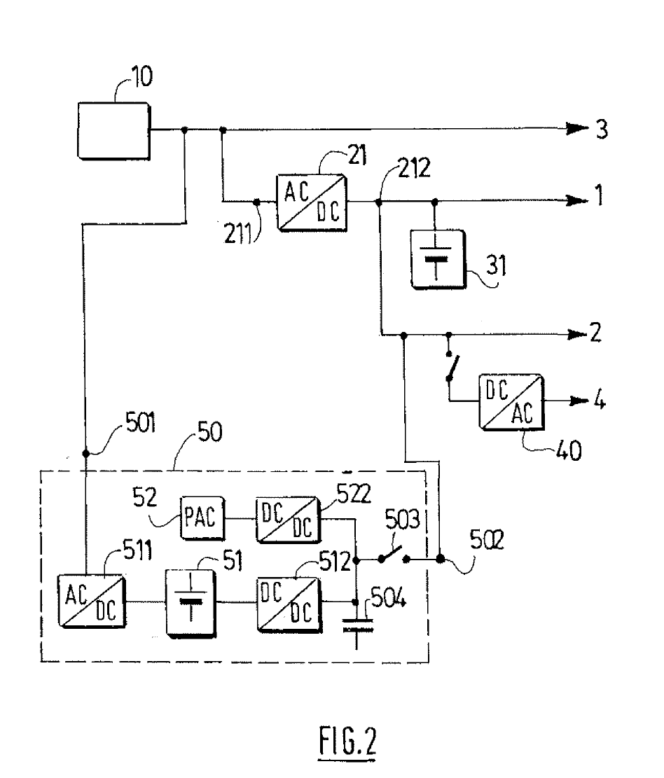

FIG. 2 is a diagram showing an installation comprising an uninterrupted power supply circuit in accordance with a first embodiment of the invention.

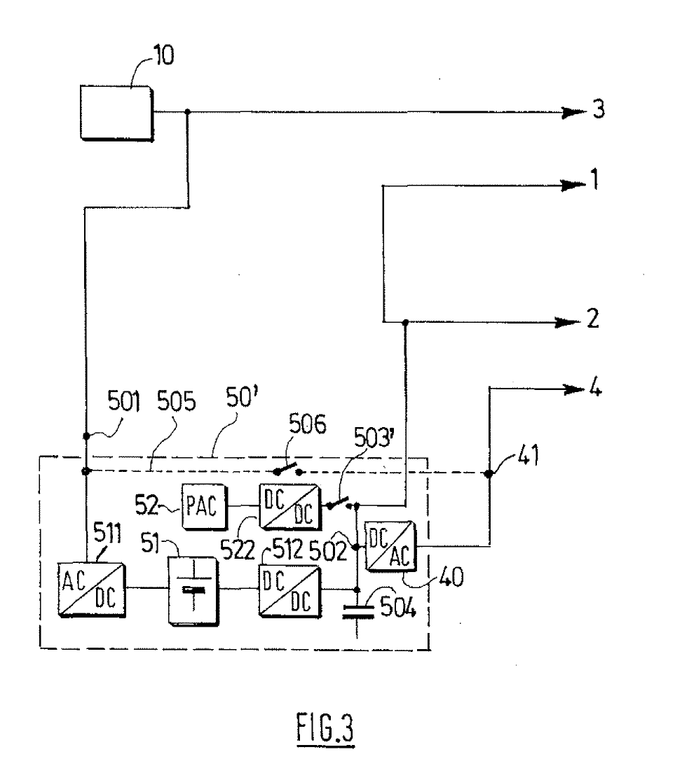

FIG. 3 is a diagram showing an installation comprising an uninterrupted power supply circuit in accordance with a second embodiment of the invention.

In FIG. 2 is represented an installation intended to power, in particular electronic, electrical equipment. As in FIG. 1, certain electronic equipment 1, 2 must be powered by direct current, for example at 48 V for telecommunications equipment. In the exemplary embodiment of FIG. 2, this electronic equipment is powered by way of an AC/DC converter 21 whose input terminal 211 is connected to the AC source 10 and whose output terminal 212 is connected to the supply bus of the installation. Other equipment 3, 4 is supplied with AC power respectively by the local electrical network or via a DC/AC converter 40 connected to the output terminal 212 of the AC/DC converter 21.

According to a first embodiment of the invention, the installation of FIG. 2 furthermore comprises an uninterrupted power supply circuit 50 which comprises, on the one hand, a battery 51 connected to the AC source 10 on an input terminal 501 of the circuit 50 by way of an AC/DC converter 511 and, on the other hand, a fuel cell 52. The battery 51 of the backup system 50 with fuel cell 52 is envisioned in particular for starting the cell 52.

The battery 51 and the fuel cell 52 are connected respectively to the output terminal 502 of the circuit 50 by way of DC/DC converters 512 and 522. A 100-Hz filtering capacitor 504 is placed at the output of the battery 51 and of the fuel cell 52.

Additionally, it may be seen in FIG. 2 that a breaker 503 is disposed on the output terminal 502 of the circuit 50 which then operates in “charger” mode.

It is appropriate to note that the solution proposed in FIG. 2 uses only a single backup battery 31 to power the equipment, thereby representing an appreciable advantage with respect to the installation of FIG. 1 for which a plurality of batteries was necessary.

Under nominal conditions, the breaker 503 is open and the various equipment is powered from the AC source 10.

In the event that the AC supply is cut off, the breaker 503 is closed and the DC supply to the electronic equipment 1, 2 and AC supply to the electrical equipment 4 is ensured by the uninterrupted power supply backup circuit or system 50. The batteries 31 and 51 serve as buffer for the starting of the circuit 50 when the supply switches over.

FIG. 3 represents a second embodiment in which a breaker 5031 is disposed between the fuel cell 52 and the output terminal 502 of the uninterrupted power supply circuit 501.

Contrary to the embodiment of FIG. 2, the power supply circuit 50′ of FIG. 3 only supplies power to the equipment 2, 3, 4 whether under nominal conditions or during an interruption of the AC supply. It is understood, with all the advantages that this represents, that, in this case, no battery is necessary for supplying backup power to the equipment 2, 3, 4 since the latter is powered continuously by the circuit 50′ and no supply interruption can therefore occur during a cutoff of the AC supply.

Under nominal conditions, the breaker 503′ is open and the uninterrupted power supply circuit 501 is always energized, but without the fuel cell being supplied.

The battery 51 can be of low capacity since it need only operate for the few seconds during which the circuit 50′ is started, which circuit is always energized and whose “ready to operate state” conditions are maintained by tapping off a part of the power which crosses the circuit 501.

In FIG. 3 may be observed the presence of a DC/AC converter 40 on the output terminal 502 of the circuit 50′, intended to supply AC power to the equipment 4.

In order to supply this equipment 4 with better efficiency, it is possible to place a short-circuit 505 between the input terminal 501 of the uninterrupted power supply circuit 50′ and an output terminal 41 of the DC/AC converter 40, the breaker 506 of the short-circuit being closed under nominal conditions and open during an interruption.

The invention thus makes it possible to under-rate the backup batteries of the circuit as well as the battery for starting the cell. The invention even makes it possible optionally to dispense with the backup batteries or to replace them with capacitors.

In the variant of FIG. 3, the backup batteries are replaced (solely) by the battery for starting the cell which still has a low rating.

Although the invention has been described in conjunction with particular embodiments, it is not limited thereby but is susceptible to modifications and variants which will be apparent to the person skilled in the art within the scope of the claims hereinafter.

The fuel cell 52 is advantageously a proton exchanger membrane (PEN) cell supplied, on the one hand, with air and on the other hand with hydrogen stored under high pressure in tanks or cylinders or under low pressure in hydride containers.

1-11. (canceled)

12: An uninterrupted power supply circuit based on an AC source, comprising a backup system with fuel cell, wherein the backup system comprises:
a) a fuel cell; and
b) a battery for starting the fuel cell connected to said AC source on an input terminal of the backup system, said starting battery and the fuel cell being connected in parallel to an output terminal of the system that is different from the input terminal.

13: The circuit of claim 12, wherein a breaker is disposed on said output terminal.

14: The circuit of claim 12, wherein a breaker is disposed between the fuel cell and said output terminal.

15: The circuit of claim 14, wherein a DC/AC converter is disposed at the level or downstream of the output terminal of said backup system.

16: The circuit of claim 15, wherein a short circuit is switchable between the input terminal of said circuit and an output terminal of said DC/AC converter.

17: The circuit of claim 12, wherein the starting battery is connected to the AC source by way of an AC/DC converter.

18: The circuit of claim 12, wherein the starting battery and the fuel cell are connected to the output terminal of the fuel cell backup system by way of respective DC/DC converters.

19: The circuit of claim 12, wherein a filtering capacitor is placed at the level of the output of the starting battery and of the fuel cell.

20: The circuit of claim 12, wherein it comprises a backup battery situated downstream of the output terminal on a supply line for powering an item of electronic equipment from the source.

21: The circuit of claim 12, wherein the backup system with fuel cell is kept energized by the AC source.

22: The circuit of claim 12, wherein the starting battery is kept charged by the AC source when said source is operating and by the fuel cell when the latter is turned on, in particular in the event of failure of the source.
